(19) United States
(12) Patent Application Publication
(10) Pub. No.: US 2011/0047552 A1
(43) Pub. Date: Feb. 24, 2011

(54) ENERGY-AWARE PROCESS ENVIRONMENT SCHEDULER

(75) Inventors: John-Francis MERGEN, Baltimore, MD (US); Joshua N. EDMISON, Malta, NY (US)

Correspondence Address: VERIZON LEGAL DEPARTMENT;PATENT MANAGEMENT GROUP, 1320 N. COURTHOUSE ROAD, 9TH FLOOR, ARLINGTON, VA, 22201-2525, US

(73) Assignee: RAYTHEON BBN TECHNOLOGIES CORP., Cambridge, MA (US)

(21) Appl. No.: 12/915,371

(22) Filed: Oct. 29, 2010

Related U.S. Application Data
(63) Continuation-in-part of application No. 12/463,589, filed on May 11, 2009.

(51) Int. Cl. G06F 9/46

(52) U.S. Cl. 718/102; 718/100

(57) ABSTRACT

A device receives a request associated with a process, and determines one or more current states of one or more process resources used to execute the process request. The device also calculates a power consumption associated with execution of the process request by the one or more process resources, and assigns an urgency for the process request, where the urgency corresponds to a time-variant parameter that indicates a measure of necessity for the execution of the process request. The device further determines whether the execution of the process request can be delayed to a future time based on the one or more current states, the power consumption, and the urgency, and causes, based on the determination, the process request to be executed or delayed to the future time.

### RELATED APPLICATION

This application is a continuation-in-part of U.S. patent application Ser. No. 12/463,589, filed May 11, 2009, the entire content of which is hereby incorporated by reference.

### BACKGROUND

Energy consumption and energy availability have become major concerns in the operation of processes (e.g., manufacturing processes, service processes, computing processes, etc.) due to costs associated with scarce natural resources. For example, in large-scale processes (e.g., industrial processes), the cost of power and the ability to provide enough power can be a limiting factor towards growth of manufacturing facilities.

### SUMMARY

According to one implementation, a method may be implemented by a computing device. The method may include receiving, by the computing device, a request associated with a process, and determining, by the computing device, one or more current states of one or more process resources used to execute the process request. The method may also include calculating, by the computing device, a power consumption associated with execution of the process request by the one or more process resources, and assigning, by the computing device, an urgency for the process request, where the urgency corresponds to a time-variant parameter that indicates a measure of necessity for the execution of the process request. The method may further include determining, by the computing device, whether the execution of the process request can be delayed to a future time based on the one or more current states, the power consumption, and the urgency, causing, by the computing device and when the execution of the process request cannot be delayed, the process request to be executed, and causing, by the computing device and when the execution of the process request can be delayed, a delay of the execution of the process request to the future time.

According to another implementation, a device may include a memory to store instructions, and a processor to execute the instructions in the memory to receive a request associated with a process, determine one or more current states of one or more process resources used to execute the process request, and calculate a power consumption associated with execution of the process request by the one or more process resources. The processor may further execute instructions in the memory to assign an urgency for the process request, where the urgency corresponds to a time-variant parameter that indicates a measure of necessity for the execution of the process request, determine whether the execution of the process request can be delayed to a future time based on the one or more current states, the power consumption, and the urgency, and cause, based on the determination, the process request to be executed or delayed to the future time.

According to still another implementation, one or more computer-readable media may store instructions executable by one or more processors. The media may store one or more instructions for: receiving a request associated with a process; determining one or more current states of one or more process resources used to execute the process request; calculating a power consumption associated with execution of the process request by the one or more process resources; assigning an urgency for the process request, where the urgency corresponds to a time-variant parameter that indicates a measure of necessity for the execution of the process request; determining whether the execution of the process request can be delayed to a future time based on the one or more current states, the power consumption, and the urgency; causing, when the execution of the process request cannot be delayed, the process request to be executed; and causing, when the execution of the process request can be delayed, a delay of the execution of the process request to the future time.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a diagram of an example environment in which systems and/or methods described herein may be implemented;

FIG. 2 is a diagram of example components of a user device depicted in FIG. 1;

FIG. 3 is a diagram of example functional components of the user device depicted in FIGS. 1 and 2;

FIG. 4 is a diagram of example functional components of a reduced energy scheduler (RES) illustrated in FIG. 3;

FIG. 5 is a diagram of an example environmental table of the RES depicted in FIG. 4;

FIG. 6 is a diagram of an example request table of the RES depicted in FIG. 4;

FIG. 7 is a diagram of an example current state table of the RES depicted in FIG. 4;

FIG. 8 is a diagram of an example historical table of the RES depicted in FIG. 4;

FIG. 9 is a flow chart of an example process for scheduling processes or process requests according to implementations described herein;

FIG. 10 is a diagram of the user device managing an example manufacturing process request; and

FIG. 11 is a diagram of the user device managing an example service process request.

### DETAILED DESCRIPTION

The following detailed description refers to the accompanying drawings. The same reference numbers in different drawings may identify the same or similar elements. Also, the following description does not limit the invention.

### Overview

Systems and/or methods described herein may schedule execution of processes and process requests, in an energy-aware way, based on levels of urgency associated with the processes or process requests, current state information associated with process resources (e.g., devices, tools, equipment, etc.), power consumption information associated with the execution of the processes and the process requests, environmental factors, etc. The systems and/or methods may consider these factors individually and/or in an interrelated manner. The systems and/or methods may operate in conjunction with an existing operating system (OS) state controller (e.g., a process scheduler and/or a hardware controller) of a user device (e.g., a computer, a server, a cluster of computers, etc.).

In one example implementation, the systems and/or methods may be utilized with processes, such as co-generation startup, inventory movement, stocking models, production queuing, manufacturing processes, service processes, etc. The systems and/or methods may enable such processes to make more efficient use of energy sources (e.g., may reduce energy usage) within a factory, a manufacturing plant, a warehouse, etc. The reduction in energy usage may reduce costs for manufacturers and service providers, may reduce carbon footprints created by processes, may reduce a need for peak power production (e.g., which may be five to ten times greater than average generation costs), etc.

The term “urgency,” as used herein, is intended to correspond to a time-based parameter or a time-variant parameter to indicate a measure of importance or a measure of necessity to execute a process or a process request. As described herein, an urgency parameter may vary through time, and not necessarily, in a linear way. This is in contrast to a priority parameter, which is typically a static measure of importance and/or is time-invariant. As will be described, a process request or a process may be assigned a level of urgency.

### Example Environment

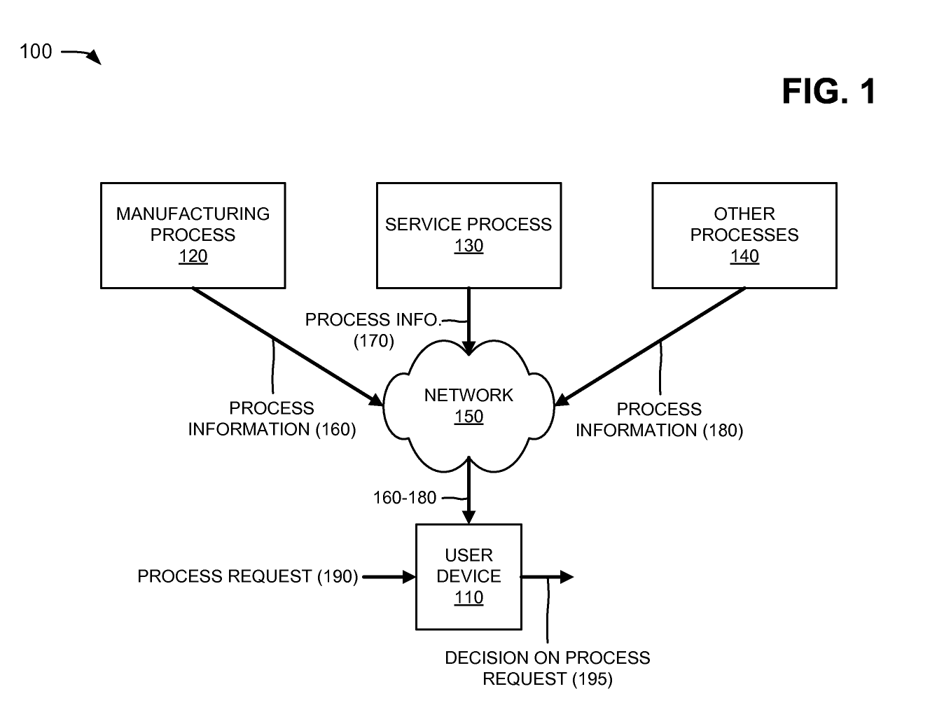

FIG. 1 is a diagram of an example environment 100 in which systems and/or methods described herein may be implemented. As illustrated, environment 100 may include a user device 110, a manufacturing process 120, a service process 130, and other processes 140 interconnected by a network 150. Components of environment 100 may interconnect via wired and/or wireless connections or links. A single user device 110, manufacturing process 120, service process 130, other processes 140, and network 150 have been illustrated in FIG. 1 for simplicity. In practice, there may be more user devices 110, manufacturing processes 120, service processes 130, other processes 140, and/or networks 150. Also, in some instances, one or more of the components of environment 100 may perform one or more tasks described as being performed by another one or more of the components of environment 100.

User device 110 may include any device that is capable of communicating with one or more of manufacturing process 120, service process 130, and other processes 140 via a network (e.g., network 150). For example, user device 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a personal computer, a workstation computer, a tablet computer, or other types of computation or communication devices.

Manufacturing process 120 may include one or more operations (e.g., performed by one or more resources, devices, machines, control systems, etc.) that add, subtract, and/or form materials in order to produce a desired finished product. A “product,” as the term is used herein, is to be broadly interpreted to include anything that may be marketed or sold as a commodity or a good. For example, a product may include a telephone, a modem, a set-top box, concrete, gasoline, paper, plastic, a computer, a television, etc. Manufacturing process 120 may also include parameters associated with the operations, devices, machines, raw materials, etc. used to produce the finished product. For example, if manufacturing process 120 is a semiconductor manufacturing process, manufacturing process 120 may include parameters associated with operations (e.g., etching, layer application, etc.), devices (e.g., etchers, chemical vapor deposition tools, etc.), raw materials (e.g., silicon, slurries, and chemicals), etc. used to produce a semiconductor wafer.

Service process 130 may include one or more operations (e.g., performed by one or more resources, people, devices, control systems, etc.) that provide a service for others. A “service,” as the term is used herein, is to be broadly interpreted to include any act or variety of work done for others (e.g., for compensation). For example, a service may include a repair service (e.g., for a product), a delivery service (e.g., for delivering a product), a telecommunication service (e.g., telephone services, Internet services, network services, radio services, television services, video services, etc.), etc. Service process 130 may include parameters associated with the operations, devices, systems, etc. used to provide the service for others. For example, if service process 130 is a delivery service (e.g., United Parcel Service, Federal Express, etc.), service process 130 may include parameters associated with operations (e.g., labeling, packaging, etc.), systems (e.g., package tracking systems), vehicles (e.g., trucks and planes), etc. used to deliver packages to customers.

Other processes 140 may include processes (and parameters associated therewith) other than manufacturing processes and service processes. For example, other processes 140 may include software processes, business processes, etc.

Network 150 may include one or multiple networks of any type. For example, network 150 may include a wired network, a wireless network, a private network, a public network, a local area network (LAN), a metropolitan area network (MAN), a wide area network (WAN), the Internet, an intranet, a telephone network (e.g., the Public Switched Telephone Network (PSTN) or a cellular network), a satellite network, and/or a computer network.

As further shown in FIG. 1, manufacturing process 120 may generate process information 160, and may provide process information 160 to user device 110 via network 150. Process information 160 may include parameters associated with manufacturing process 120, such as, for example: power consumed by manufacturing process 120 (or resources of manufacturing process 120); production rates of manufacturing process 120 (or resources of manufacturing process 120); environmental conditions associated with manufacturing process 120; raw material usage by manufacturing process 120; etc. Service process 130 may generate process information 170, and may provide process information 170 to user device 110 via network 150. Process information 170 may include parameters associated with service process 130, such as, for example: power consumed by service process 130 (or resources of service process 130); service rates of service process 130 (or resources of service process 130); transportation information associated with service process 130; inventory information associated with service process 130; etc. Other processes 140 may generate process information 180, and may provide process information 180 to user device 110 via network 150. Process information 180 may include information similar to process information 160 and 170.

User device 110 may receive process information 160-180 (e.g., from network 150), and may receive a process request 190 (e.g., from a user of user device 110). Process request 190 may include a request to alter one or more operations, processes, devices, parameters, etc. associated with manufacturing process 120, service process 130, or other processes 140. User device 110 may determine whether to implement process request 190 based on process information 160-180. For example, user device 110 may determine whether to implement process request 190 (e.g., in manufacturing process 120) based on process information 160 received from manufacturing process 120. User device 110 may output a decision on whether or not to implement process request 190, as indicated by reference number 195. In one example implementation, if process request 190 may be delayed, user device 110 may decide to delay implementation of process request 190 in order to conserve energy. If user device 110 determines that process request 190 cannot be delayed, user device 110 may enable process request 190 to be executed.

Although FIG. 1 shows example components of environment 100, in other implementations, environment 100 may include fewer components, different components, differently arranged components, or additional components than depicted in FIG. 1.

### Example User Device Architecture

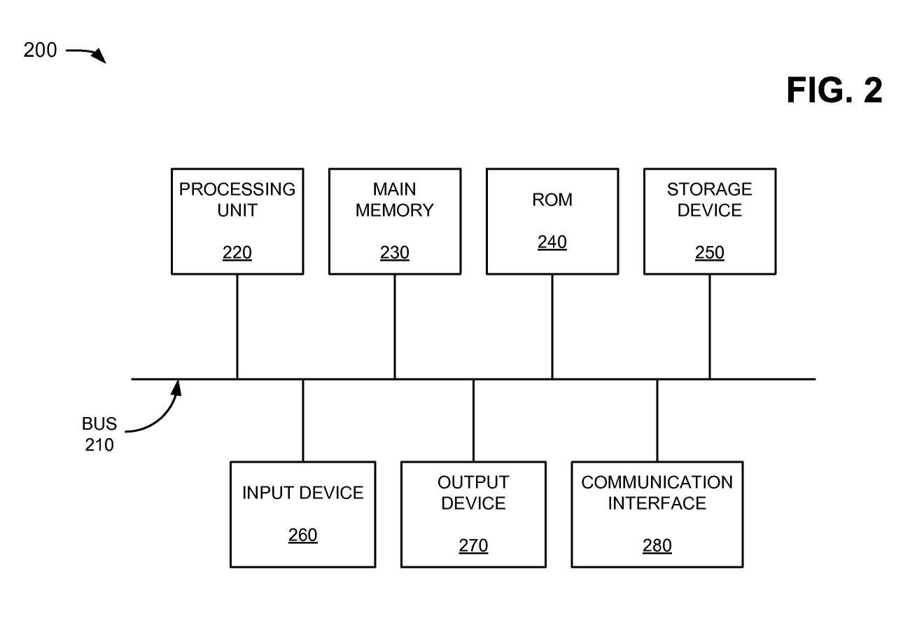

FIG. 2 is a diagram of example components of a device 200 that may correspond to user device 110 (FIG. 1). As illustrated, device 200 may include a bus 210, a processing unit 220, a main memory 230, a read only memory (ROM) 240, a storage device 250, an input device 260, an output device 270, and/or a communication interface 280. Bus 210 may include a path that permits communication among the components of device 200.

Processing unit 220 may include one or more processors, microprocessors, application-specific integrated circuits (ASICs), field-programmable gate arrays (FPGAs), or other types of processing units that may interpret and execute instructions. Main memory 230 may include a random access memory (RAM) or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, a touch screen, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a physical or logical memory device. A logical memory device may include memory space within a single physical memory device or spread across multiple physical memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may include fewer components, different components, differently arranged components, or additional components than depicted in FIG. 2. Alternatively, or additionally, one or more components of device 200 may perform one or more other tasks described as being performed by one or more other components of device 200.

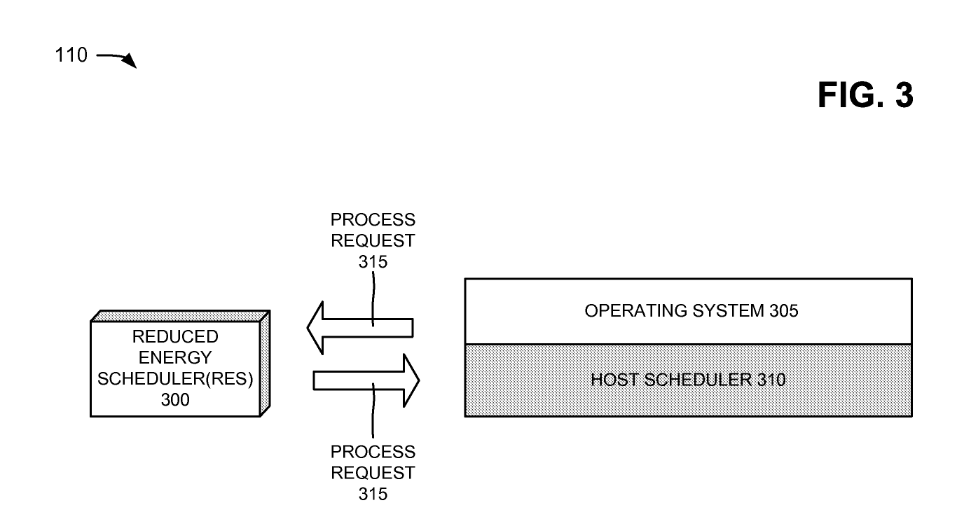

FIG. 3 is a diagram of example functional components of user device 110. In one implementation, the functions described in connection with FIG. 3 may be performed by one or more components of device 200 (FIG. 2). As illustrated in FIG. 3, user device 110 may include a reduced energy scheduler (RES) 300, an operating system (OS) 305, and a host scheduler 310.

RES 300 may include hardware or a combination of hardware and software that may manage the execution of processes and/or process requests. RES 300 may determine a time when a process and/or a process request is to be executed based on urgency, state information, power consumption, environmental factors, etc. associated with the process and/or process request. RES 300 may consider these factors within a time window, such as, for example, a current time period and/or a future time period. The term “process request,” is intended to be broadly interpreted to include, for example, a message which is presented to an OS (e.g., OS 305) and requests that an operation be performed (e.g., change a process operation, add a new process operation, etc.). By way of example, a process request may include a process name, a process location, and additional information to execute the process (e.g., operation parameters, process parameters, process inputs, process requirements, etc.).

RES 300 may simulate a process (e.g., based on a process request) in order to determine if the process may be improved or delayed in order to reduce power consumption associated with the process. For example, RES 300 may simulate power utilization of a process, process throughput (e.g., the number of processes that complete their execution per unit of time), process turnaround (e.g., the amount of time to execute a particular process), process response time (e.g., the amount of time it takes from when a process request is submitted until a response is produced), as well as other parameters associated with the management of processes and/or process requests.

RES 300 may also manage an on-going process (e.g., manufacturing process 120 and/or service process 130) and may determine to remove the process (or a portion or operation of the process) if it has a low urgency and/or power consumption can be reduced. Additionally, or alternatively, RES 300 may remove a process request when the execution of the process request is no longer needed. For example, a process request may correspond to executing a process to make additional product (e.g., for a rush order). Thereafter, the rush order may be canceled by the customer. In such an instance, RES 300 may be informed to discard the process request. RES 300 will be described in greater detail below.

OS 305 may include hardware or a combination of hardware and software that may provide an interface between hardware and applications. In one example, OS 305 may correspond to a Windows OS, a MAC OS, a Linux OS, or the like.

Host scheduler 310 may include hardware or a combination of hardware and software that may correspond to a scheduler included in user device 110 (e.g., in OS 305). Host scheduler 310 may interact with one or more devices that control execution of process operations (e.g., a manufacturing material requirements planning (MRP) system), and may schedule process requests with the one or more control devices. Alternatively, or additionally, host scheduler 310 may receive process requests from the one or more control devices, and may provide the process requests to RES 300.

As illustrated in FIG. 3, in an example operation, RES 300 may obtain a process request 315 that is to be executed. Process request 315 may include a request to add, delete, or delay one or more operations associated with a process (e.g., one of processes 120-140). In an example implementation, RES 300 may obtain process request 315 based on an inter-process communication link. For example, RES 300 may retrieve process request 315 from a shared resource (e.g., a memory) that stores process requests. Additionally, or alternatively, RES 300 may obtain process request 315 based on a communication (e.g., via a communication channel) with host scheduler 310. For example, host scheduler 310 may push process request 315, via the communication channel, to RES 300.

As will be described herein, RES 300 may determine an appropriate time for process request 315 to be executed based on power consumption and urgency. RES 300 may utilize a bin-packing approach versus a knapsack approach or a decaying queue approach for simulating the execution of the processes and/or process requests. For example, RES 300 may utilize a sliding time window bin packing approach to determine the best power consumption permitted within the time window. RES 300 may utilize various parameters (e.g., urgency associated with process request 315, current process state information, power consumption associated with the execution of process request 315, and environmental factors) to determine the appropriate time to execute process request 315. When RES 300 determines the appropriate time, RES 300 may send process request 315 to host scheduler 310. Host scheduler 310 may then provide for the execution of process request 315 by a process (e.g., one of processes 120-140). For example, host scheduler 310 may inform one or more devices that control execution of process operations (e.g., a MRP system) of a time to execute process request 315. Such an arrangement may permit balancing across a process (e.g., manufacturing process 120), logistics associated with the process, and inventory associated with the process.

In one example implementation, RES 300 may receive process request 315, and may determine current states (e.g., idle, operational, etc.) of process resources (e.g., devices, components, etc. associated with one of processes 120-140) to execute process request 315. RES 300 may determine power consumption associated with execution of process request 315, and may receive environmental factors associated with the process resources. RES 300 may assign a level of urgency to process request 315, and may determine whether execution of process request 315 may be delayed (e.g., to conserve power for one of processes 120-140). HRH 300 determines that process request 315 may be delayed, RES 300 may delay execution of process request 315 until a later time. If RES 300 determines that process request 315 may not be delayed, RES 300 may send process request 315 to host scheduler 310, and host scheduler 310 may provide for the execution of process request 315 by a process (e.g., one of processes 120-140).

Although FIG. 3 shows example functional components of user device 110, in other implementations, user device 110 may include fewer functional components, different functional components, differently arranged functional components, or additional functional components than depicted in FIG. 3. Alternatively, or additionally, one or more functional components of user device 110 may perform one or more other tasks described as being performed by one or more other functional components of user device 110. For example, RES 300 may be provided in a different device than OS 305 and host scheduler 310, so that RES 300 may manage one or more processes and/or process requests associated with one or more processes.

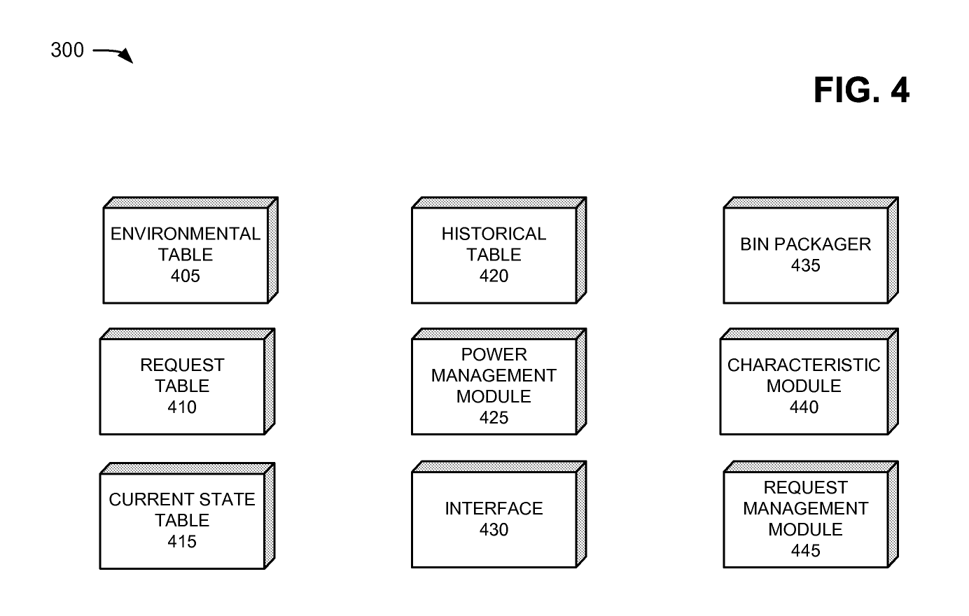

FIG. 4 is a diagram of example functional components of RES 300. In one implementation, the functions described in connection with FIG. 4 may be performed by one or more components of device 200 (FIG. 2). As illustrated in FIG. 4, RES 300 may include an environmental table 405, a request table 410, a current state table 415, a historical table 420, a power management module 425, an interface 430, a bin packager 435, a characteristic module 440, and a request management module 445.

Environmental table 405 may include an arrangement of data corresponding to external environmental variables associated with a process (e.g., one of processes 120-140). For example, environmental table 405 may include environmental variables, such as, temperature, thermal mass (i.e., the amount of heat the environment can absorb for each degree of temperature rise), air pressure, humidity, density altitude (e.g., a measure of air pressure and enthalpy of the air) associated with one of processes 120-140. In another example, environmental table 405 may include current environmental information associated with one of processes 120-140, such as a state of the process (e.g., executing, standby, etc.), production demands, process utilization, power availability, target performance, current power consumption, and/or cooling reserves (e.g., ice reserves, thermal mass for process heat, etc.).

RES 300 may utilize environmental table 405 to calculate various loads that may be placed on the thermal management capabilities of the process (or components executing the process). For example, RES 300 may accurately anticipate the need for active cooling, co-generation, or other forms of power consumptions, and/or may accurately anticipate an addition to the energy load or other types of resources utilized by the process. RES 300 may receive the environmental variable information from, for example, sensors associated with one of processes 120-140.

Request table 410 may include an arrangement of data corresponding to requests (e.g., process request 315) for the processing capabilities of a process (e.g., one of processes 120-140). For example, request table 410 may include process requests that exist for current MRP systems, requests for power friendly processes, an urgency parameter, a resource need parameter, etc.

The urgency parameter may indicate a measure of how important it is to execute a process immediately and at what rate it increases in urgency. The urgency parameter may include a current urgency and a projected urgency. The projected urgency may be calculated based on an urgency rate and current urgency. The urgency rate may indicate a rate in which urgency increases through time. By way of example, the urgency parameter may indicate a low level of urgency at a time T(0) for executing an operation of a process. However, at a time T(N), the urgency parameter may indicate an extremely high level of urgency for executing the operation. RES 300 may anticipate, at time T(0), the extremely high level of urgency at time T(N), based on the urgency parameter (i.e., the projected urgency). In one implementation, an initial or default urgency and the urgency rate associated with the urgency parameter may be specified by a system administrator or a production planner.

The resource need parameter may indicate the type of resources needed to execute a process. For example, the resource need parameter may include information, such as, resources available for a process, energy supply needs for process operations, etc. The resource need parameter may also include duty cycle information (e.g., a time period that a resource would be utilized to execute the process). In one implementation, the resource need parameter may be specified by a production planner or an order management system.

Current state table 415 may include an arrangement of data corresponding to a current state of all power consuming devices and/or operations associated with a process (e.g., one of processes 120-140). For example, the starting of an oven, the moving of material, and the starting/stopping of a production line all represent power consuming actions that decrease after a device(s) is in use. In one specific example, if an oven is hot it may be prudent to shut the oven down when use of the oven is not anticipated for a period of time and when reheating the oven is not a burden. However, if a process request to utilize the oven was delayed (e.g., due to low urgency from an earlier high power period), RES 300 may decide to instruct a MRP system to take advantage of the hot oven. Based on the information in current state table 415, RES 300 may make power-up and power-down decisions. Additionally, in some implementations, current state table 415 may include data corresponding to a projected state of all of the power consuming components of a process. The projected state may correspond to the state of all the power consuming components at a future time.

Historical table 420 may include an arrangement of historical data relating to the execution or non-execution of process requests and/or processes during a previous time period, and state information associated with components of the process during a previous time period. Based on the information in historical table 420, RES 300 may make power-up and power-down decisions. For example, RES 300 may have a process request to utilize a heater in a process. Historical table 420 may indicate that the heater powers up every 30 minutes. Based on this information, RES 300 may delay execution of the process request, instead of powering up the heater now, since it is probable that the heater will power up again in the near future (i.e., within another 30 minute period). Conversely, historical table 420 may indicate that the heater has not powered up within the past 4 hours. Based on this information, RES 300 may not delay execution of the process request, since it is probable that the heater will not power up again in the near future.

Power management module 425 may include rules for managing the state of components associated with a process (e.g., one of processes 120-140). For example, power management module 425 may include rules relating to hibernation, sleep, idle, stand-by, speed, transmit power, and other settings related to the state and/or characteristic of a component of the process. In some instances, user device 110 may provide a user interface for these rules. For example, a systems preferences/energy saver or settings/power menu may be provided.

In one example implementation, power management module 425 may provide an interface that presents requests for turning devices on and off and for controlling an order, a volume, and a type of production in order to control power consumption. Power management module 425 may be added as an application to existing MRP environments, and may provide power scheduling interfaces in existing factory and warehouse environments. Power management module 425 may enable RES 300 to examine needs of requesting systems (e.g., sales, inventory, power utility needs, etc.) and an anticipated arrival time of those needs.

Interface 430 may provide an interface to the process management of a factory/warehouse control and tasking system (e.g., a MRP system). Interface 430 may enable RES 300 to present requests to an existing scheduler (e.g., host scheduler 310) to start, stop, or suspend process operations. RES 300 (via interface 430) may act as an intermediary between the MRP system and a process request (e.g., process request 315). Interface 430 may enable RES 300 to be provided as an add-on to a MRP system or integrated into a MRP system.

Bin packager 435 may utilize a bin-packing algorithm for scheduling the execution of processes and process requests. Bin packager 435 may utilize a sliding time window to attain the best power consumption permitted within the time window. Bin packager 435 may determine, based on the aggregation of the other components, which (and when) processes and process requests are executed and which (and when) processes and processes requests are delayed for execution. Bin packager 435 may also determine which (and how) processes and process requests are executed. For example, bin packager 435 may determine whether a process may be executed in a degraded mode (e.g., to minimize power consumption and/or the utilization of resources) or not. Bin packager 435 may manage and/or utilize data in various tables (e.g., environmental table 405, request table 410, current table 415, and/or historical table 420) to make various determinations related to the scheduling and/or execution of processes and process requests. For example, bin packager 435 may schedule a process request or process based on its urgency and the ability of the process to service the process request without requiring additional power consuming components. In some instances, bin packager 435 may remove the process request from the current power consuming bin when the process request has, for example, a low urgency, a low priority, and power consumption can be reduced. In such instances, the process request may be placed in a future power consuming bin. Bin packager 435 may re-evaluate whether the process request should be executed at a future time. In some instances, the urgency level of the process request may change (e.g., from low urgency to a higher level of urgency) as it ages through time. Nevertheless, bin packager 435 may delay the execution of the process request or execute the process request in an energy-aware way without sacrificing system needs.

Characteristic module 440 may include functions that relate to power, thermal, and transient characteristics of a process (e.g., one of processes 120-140). By way of example, these functions may correspond to power consumption curves, thermal curves, and transient curves. For example, a power consumption curve may correspond to an operational state of a component (e.g., running, shut-off) vis-à-vis power consumption, or other types of characteristics, such as load capacity (e.g., number of operations) vis-à-vis power consumption. A transient curve may correspond to the operational state (e.g., transitioning from shut-down to operation) or other characteristics vis-à-vis power consumption. A thermal curve may correspond to thermal characteristics associated with various components of the process vis-à-vis power consumption. Characteristic module 440 may enable RES 300 to manage power consumption associated with various components of the process. For example, characteristic module 440 may include a function that relates process heat needs (e.g., based on environmental factors, such as external air temperature) to co-generation from waste heat. Characteristic module 440 may enable RES 300 to anticipate power trade-offs and to moderate the starting and running of a process.

Request management module 445 may manage process requests. For example, a process request may originate from the OS of user device 110, a MRP system, a user's actions, a network service, or other sources. Request management module 445 may receive the process request, via interface 430, and may store the process request in request table 410. Additionally, request management module 445 may send the process request, via interface 430, to host scheduler 310, to be scheduled for execution by a process. A process request managed by request management module 445 may include, in addition to normal or conventional request information, other types of information, such as, for example, urgency information, current and anticipated device state information, power consumption information associated with the execution of processes and process requests, and environmental factors.

Although FIG. 4 shows example functional components of RES 300, in other implementations, RES 300 may include fewer functional components, different functional components, differently arranged functional components, or additional functional components than depicted in FIG. 4. Alternatively, or additionally, one or more functional components of RES 300 may perform one or more other tasks described as being performed by one or more other functional components of RES 300.

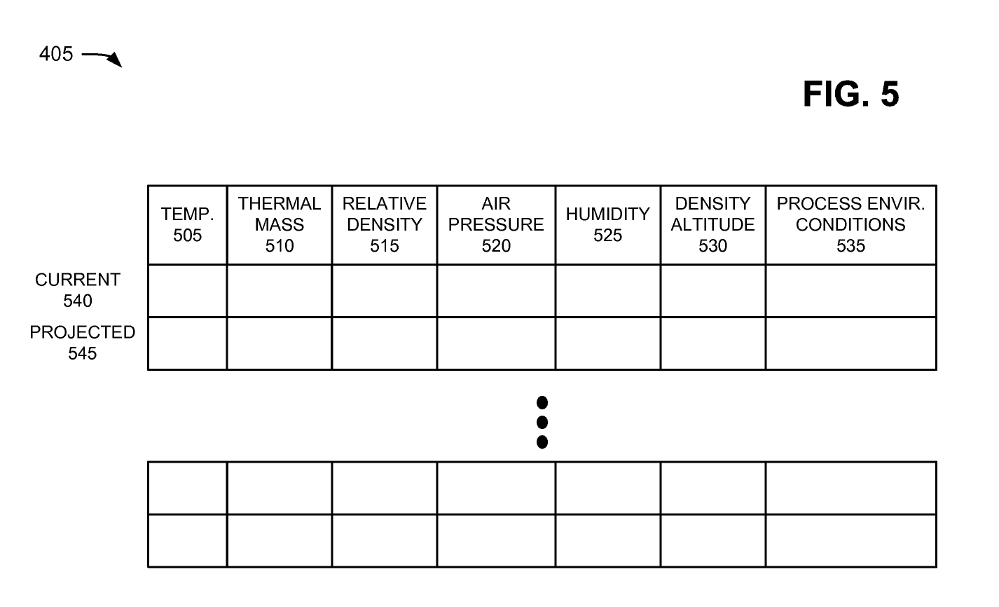

FIG. 5 is a diagram of an example environmental table 405. As illustrated, environmental table 405 may include a temperature field 505, a thermal mass field 510, a relative density field 515, an air pressure field 520, a humidity field 525, a density altitude field 530, and a process environmental conditions field 535.

Temperature field 505, thermal mass field 510, relative density field 515, air pressure field 520, humidity field 525, and density altitude field 530, may correspondingly include information related to temperature, thermal mass, relative density, air pressure, humidity, and density altitude associated with a process (e.g., one of processes 120-140). Process environmental conditions field 535 may include current environmental information associated with one of processes 120-140, such as a state of the process (e.g., executing, standby, etc.), production demands, process utilization, power availability, target performance, current power consumption, cooling reserves (e.g., ice reserves, thermal mass for process heat, etc.), etc.

Additionally, environmental table 405 may include a current field 540 and a projected field 545. Current field 540 and projected field 545 may relate to a current time and a future time, respectively. For example, environmental table 405 may provide, for each of temperature, thermal mass, relative density, air pressure, humidity, density altitude, and process environment condition, a current value and an projected or predicted value (e.g., for a future time) for each environmental variable. In some instances, the temperature may be the same with respect to a current value and a projected value. In other instances, the temperature may be different with respect to the current value and the projected value. By way of example, a device of a process may be subject to direct sunlight later in the day, but not earlier in the day. In this instance, the difference in temperature between current and projected values may be periodic (i.e., a daily occurrence). In other instances, this may not be the case. For example, the difference in temperature between current and projected values may relate to resources running while a process is executing, either currently, or at a future time, in a controlled environment, etc.

Although FIG. 5 illustrates example information that may be included in environmental table 405, in other implementations, environmental table 405 may include additional information, less information, or different types of information than depicted in FIG. 5.

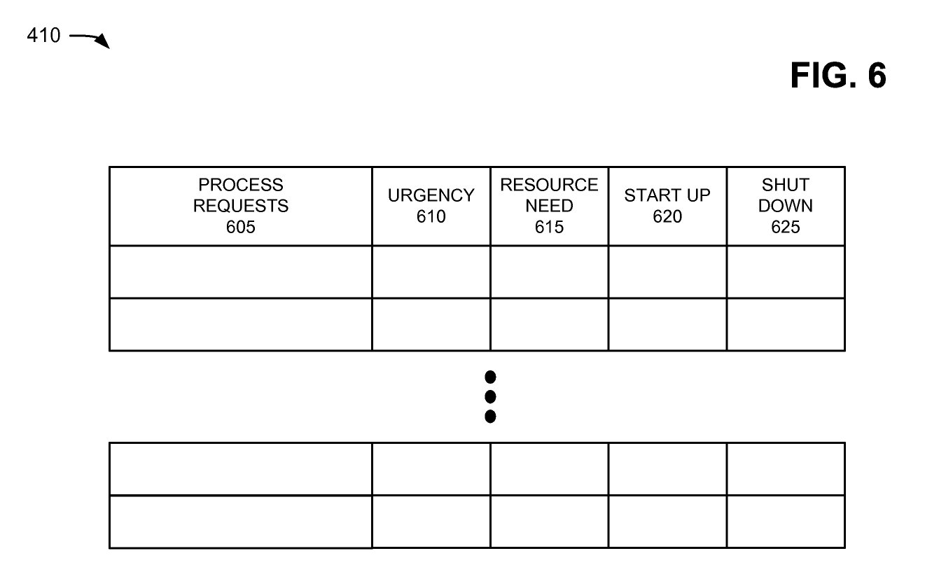

FIG. 6 is a diagram of an example request table 410. As illustrated, request table 410 may include a process requests field 605, an urgency field 610, a resource need field 615, a start up field 620, and a shut down field 625.

Process requests field 605 may include information associated with process requests (e.g., process request 315). Depending on the process and the type of process request, the process request information may vary. For example, in a manufacturing process, a process request may correspond to starting a tool, converting raw materials into a finished product, calculating a throughput of a tool, etc.

Urgency field 610 may include urgency parameter information, as previously described with respect to FIG. 4. Resource need field 615 may include resource need parameter information, as previously described with respect to FIG. 4.

Start up field 620 may include start up information associated with one or more components of a process (e.g., one of processes 120-140). For example, in a manufacturing process, start up field 620 may include start up information associated with a tool, a set of tools, a system, etc.

Shut down field 625 may include shut down information associated with one or more components of a process (e.g., one of processes 120-140). For example, in a service process, shut down field 625 may include shut down information associated with an inventory system, a packaging device, etc.

Although FIG. 6 illustrates example information that may be included in request table 410, in other implementations, request table 410 may include additional information, less information, or different types of information than depicted in FIG. 6.

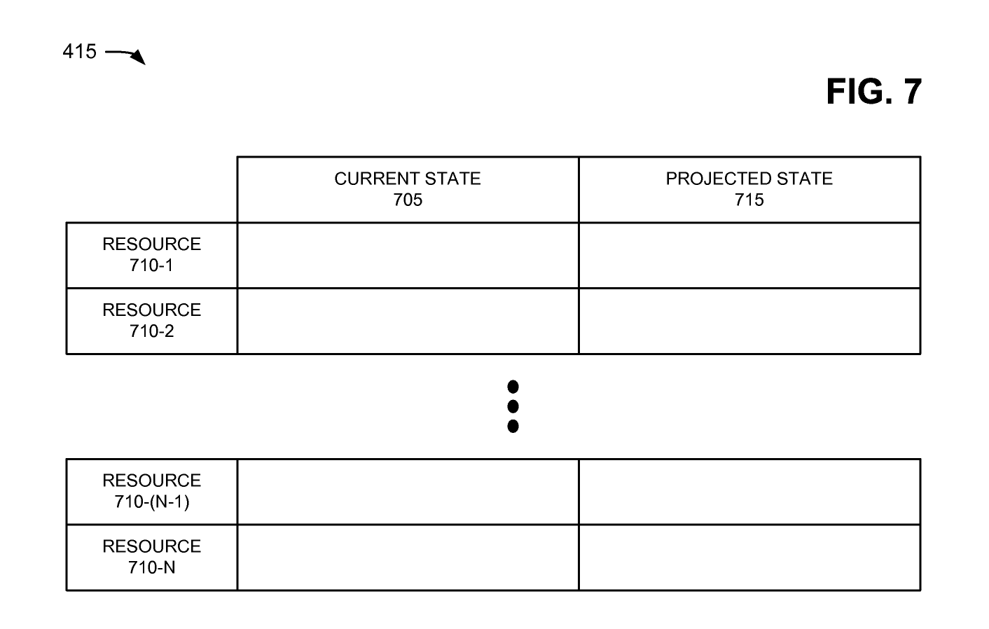

FIG. 7 is a diagram of an example current state table 415. As illustrated, current state table 415 may include a current state field 705 and corresponding resource fields 710-1 through 710-N (referred to generically as “resource field 710”). In some implementations, current state table 415 may include a projected state field 715.

Current state field 705 may include information related to a current state of a resource (e.g., a component, a system, etc.) of a process (e.g., one of processes 120-140). Resource field 710 may represent a particular resource of a process. For example, if resource field 710 pertains to a manufacturing tool, current state field 705 may indicate that the manufacturing tool is in an operational state, an idle state, a shut down state, etc.

Projected state field 715 may include information related to the projected state of a resource of a process. RES 300 may identify a projected state of a resource based on environmental table 405, request table 410, and/or historical table 420. For example, if resource field 710 corresponds to a computer system, projected state field 710 may indicate that the computer system is operating at capacity or at a portion of capacity.

Although FIG. 7 illustrates example information that may be included in current state table 415, in other implementations, current state table 415 may include additional information, less information, or different types of information than depicted in FIG. 7.

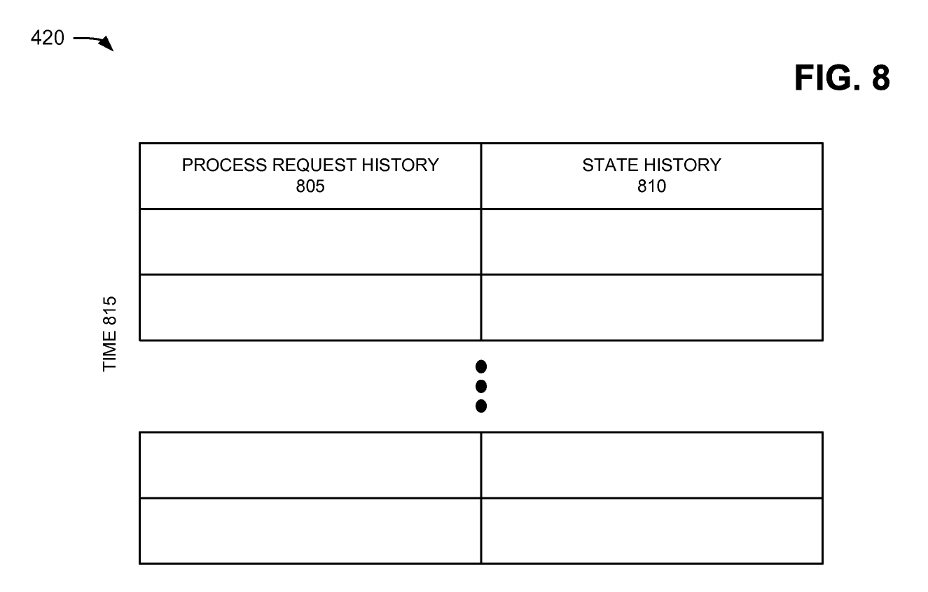

FIG. 8 is a diagram of an example historical table 420. As illustrated, historical table 420 may include a process request history field 805 and a state history field 810.

Process request history field 805 may include information related to execution or non-execution of processes (e.g., one of processes 120-140) or process requests (e.g., process request 315) within a period of time. In addition to which (and when) a process or process request was executed or not executed, process history information field 805 may include a duration associated with execution of the process, the type of process, a frequency of execution, and/or other types of process history information (e.g., whether the process was executed in a degraded mode).

State history field 810 may include information related to states of components of a process (e.g., one of processes 120-140) within a period of time. For example, state history field 810 may indicate that a component of a process was in an idle state for a certain period of time and was in an operational state for another period of time.

As further shown in FIG. 8, process request history field 805 and state history field 810 may be associated with a time 815. Time 815 may represent a historical time period (e.g., one day, two days, one month, etc.) in which the process request history information and state history information are associated. Time 815 may be user-configurable or may be automatically set by user device 110, a MRP system, etc.

Although FIG. 8 illustrates example information that may be included in historical table 420, in other implementations, historical table 420 may include additional information, less information, or different types of information than depicted in FIG. 8.

### Example Process

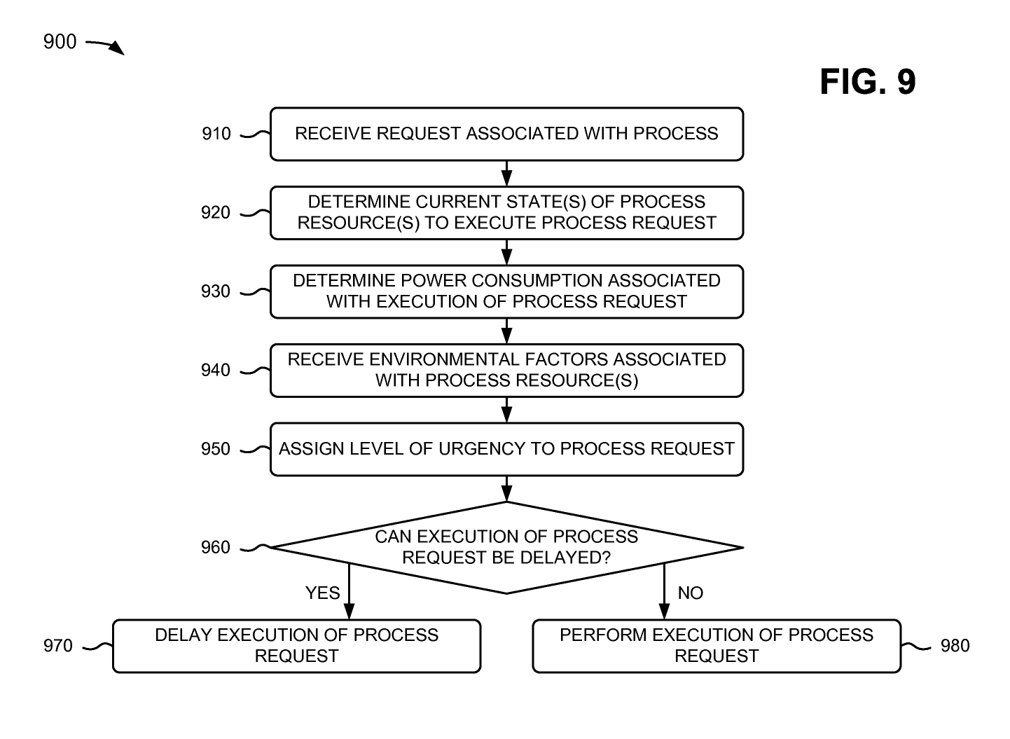

FIG. 9 is a flow chart of an example process 900 for scheduling processes or process requests according to implementations described herein. In one implementation, process 900 may be performed by user device 110 (e.g., via RES 300). In another implementation, some or all of process 900 may be performed by another device in conjunction with user device 110. For example, if RES 300 is implemented in a process control system (e.g., a MRP system), process 900 may be performed by the process control system (e.g., via execution of RES 300).

As shown in FIG. 9, process 900 may include receiving a request associated with a process (block 910), and determining current state(s) of process resource(s) to execute the process request (block 920). For example, in implementations described above in connection with FIG. 3, RES 300 may obtain process request 315 that is to be executed. Process request 315 may include a request to add, delete, or delay one or more operations associated with a process (e.g., one of processes 120-140). In one example, RES 300 may obtain process request 315 based on an inter-process communication link. RES 300 may receive process request 315, and may determine current states (e.g., idle, operational, etc.) of process resources (e.g., devices, components, etc. associated with one of processes 120-140) to execute process request 315. In one example, RES 300 may utilize current state table 415 to determine the current states of process resources.

As further shown in FIG. 9, process 900 may include determining power consumption associated with execution of the process request (block 930), and receiving environmental factors associated with the process resource(s) (block 940). For example, in implementations described above in connection with FIG. 3, RES 300 may determine power consumption associated with execution of process request 315. In one example, request table 410 of RES 300 may identify the resources needed to execute the process request, and current state table 415 may include the current state of the process. Based on request table 410 and current state table 415, RES 300 may determine the power consumption needed to execute the process request. RES 300 may receive environmental factors associated with the process resources. In one example, RES 300 may receive environmental factor information from sensors of the process. Environmental table 405 may store the received environmental factors.

Returning to FIG. 9, process 900 may include assigning a level of urgency to the process request (block 950), and determining whether execution of the process request can be delayed (block 960). For example, in implementations described above in connection with FIG. 3, RES 300 may assign a level of urgency to process request 315, and may determine whether execution of process request 315 may be delayed (e.g., to conserve power for one of processes 120-140). In one example, request table 410 may include an urgency field 610 that indicates a measure of urgency of the process request. In another example, bin packager 435 of RES 300 may determine whether execution of the process request may be delayed based on the current state of the process, the power consumption associated with the execution of the process request, environmental factors, and the urgency.

As further shown in FIG. 9, if it is determined that execution of the process request may be delayed (block 960—YES), process 900 may include delaying execution of the process request (block 970). If it is determined that execution of the process request may not be delayed (block 960—NO), process 900 may include performing execution of the process request (block 980). For example, in implementations described above in connection with FIG. 3, if RES 300 determines that process request 315 may be delayed, RES 300 may delay execution of process request 315 until a later time. In one example, bin packager 435 may delay the execution of the process request until a future time. At such future time, bin packager 435 may determine whether the execution of the process request may be delayed or not. If RES 300 determines that process request 315 may not be delayed, RES 300 may send process request 315 to host scheduler 310, and host scheduler 310 may provide for the execution of process request 315 by a process (e.g., one of processes 120-140).

Although FIG. 9 illustrates an example process 900, in other implementations, fewer, additional, or different operations may be performed. For example, RES 300 may determine whether the execution of the process request may be delayed to the future time based on information, in addition to, or instead of, current state, power consumption, and urgency. In one implementation, RES 300 may identify process requests scheduled to be executed at the future time and may calculate the projected power consumption to execute those process requests. Based on this information, RES 300 may determine whether the execution of the process request may be delayed to the future time. Additionally, or alternatively, RES 300 may determine a projected state of the process based on environmental table 405, request table 410, and/or historical table 420. Based on the projected state, RES 300 may determine whether the execution of the process request may be delayed to the future time. Additionally, or alternatively, a threshold value of urgency may be utilized to determine when the process request may be executed. For example, RES 300 may compare the urgency associated with the process request to the threshold value of urgency. If the urgency exceeds the threshold value of urgency, RES 300 may determine that the execution of the process request cannot be delayed.

Additionally, or alternatively, RES 300 may determine a projected urgency for the process request based on the urgency rate. Based on the projected urgency, RES 300 may determine whether execution of the process request may be delayed to the future time. Additionally, or alternatively, RES 300 may determine the resources or components needed to execute the process request, as illustrated in resource need field 615 (FIG. 6). Based on the resources needed, RES 300 may determine whether execution of the process request may be delayed to the future time. Additionally, or alternatively, RES 300 may determine whether execution of the process request may be delayed to the future time based on characteristic module 440. Additionally, or alternatively, RES 300 may determine whether the process request may be executed in a degraded mode instead of delaying the processing request to the future time. For example, RES 300 may permit the execution of a process request with a limited set of resources associated with the execution of the process.

### Examples

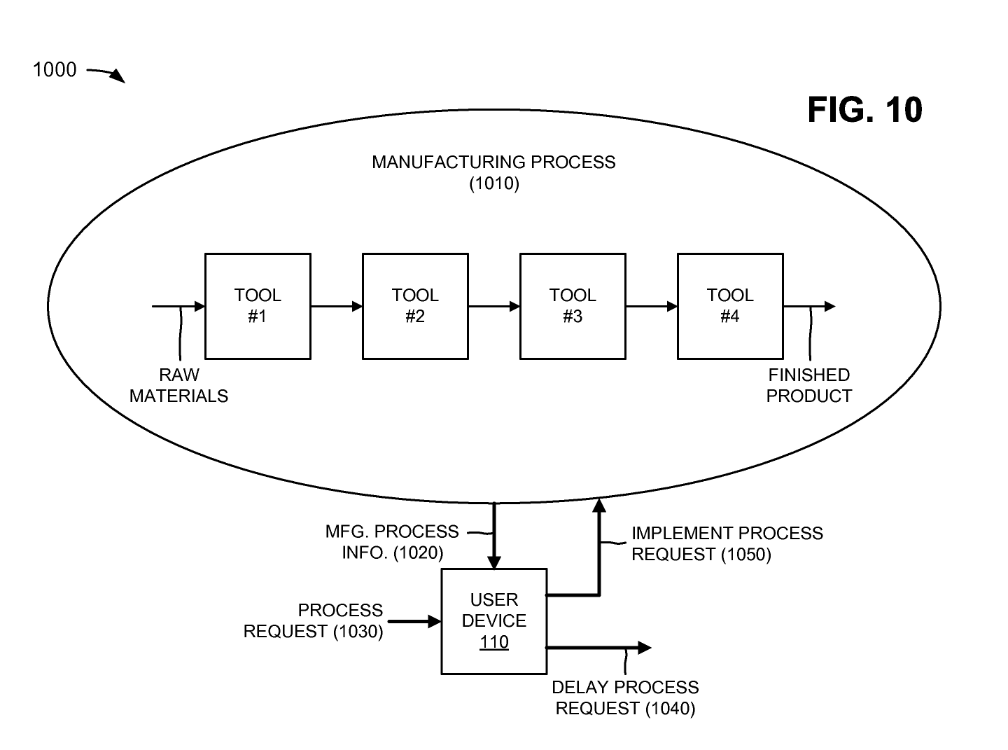

FIG. 10 is a diagram 1000 of user device 110 managing an example manufacturing process request. As illustrated, user device 110 may be associated with and may communicate with a manufacturing process 1010. Manufacturing process 1010 may include the features described above in connection with manufacturing process 120 (FIG. 1). As shown in FIG. 10, manufacturing process 1010 may include four tools (labeled 1 through 4). The first tool may receive raw materials, may process the raw the materials, and may provide the processed raw materials to the second tool. The second, third, and fourth tools may further process the raw materials, until a finished product is output by the fourth tool.

Based on the operation of the four tools, manufacturing process 1010 may generate manufacturing process information 1020. Manufacturing process information 1020 may include parameters associated with manufacturing process 1010, such as, for example: power consumed by manufacturing process 1010 (or resources of manufacturing process 1010); production rates of manufacturing process 1010 (or resources of manufacturing process 1010); environmental conditions associated with manufacturing process 1010; raw material usage by manufacturing process 1010; etc.

User device 110 may receive manufacturing process information 1020 (e.g., from manufacturing process 1010), and may receive a process request 1030 (e.g., from a user of user device 110). Process request 1030 may include a request to alter one or more operations, processes, devices, parameters, etc. associated with manufacturing process 1010. User device 110 may determine whether to implement process request 1030 based on manufacturing process information 1020. User device 110 may output a decision on whether or not to implement process request 1030. In one example, if process request 1030 may be delayed, user device 110 may decide to delay implementation of process request 1030 in order to conserve energy, as indicated by reference number 1040. Delaying process request 1030 may conserve energy because, for example, process request 1030 may cause an additional tool to be utilized in manufacturing process 1010. If user device 110 determines that process request 1030 cannot be delayed, user device 110 may enable process request 1030 to be implemented in manufacturing process 1010 (e.g., modify the third tool's operating parameters), as indicated by reference number 1050.

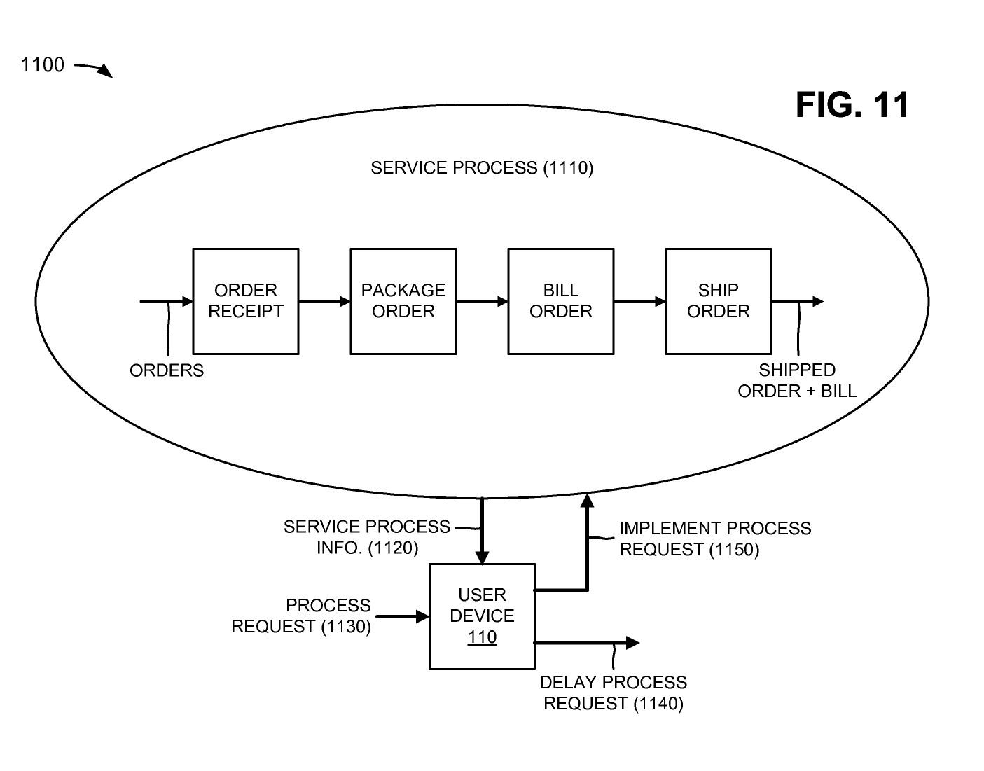

FIG. 11 is a diagram 1100 of user device 110 managing an example service process request. As illustrated, user device 110 may be associated with and may communicate with a service process 1110. Service process 1110 may include the features described above in connection with service process 130 (FIG. 1). As shown in FIG. 11, service process 1110 may include an order receipt system that receives and processes orders received from customers. A package order system packages processed orders received from the order receipt system. Service process 1110 also includes a bill order system that bills packaged orders received from the package order system. A ship order system ships, to the customers, the packaged orders and the bills received from the bill order system.

Based on the operation of the four systems, service process 1110 may generate service process information 1120. Service process information 1120 may include parameters associated with service process 1110, such as, for example: power consumed by service process 1110 (or resources of service process 1110); service rates of service process 1110 (or resources of service process 1110); transportation information associated with service process 1110; inventory information associated with service process 1110; etc.

User device 110 may receive service process information 1120 (e.g., from service process 1110), and may receive a process request 1130 (e.g., from a user of user device 110). Process request 1130 may include a request to alter one or more operations, processes, devices, parameters, etc. associated with service process 1110. User device 110 may determine whether to implement process request 1130 based on service process information 1120. User device 110 may output a decision on whether or not to implement process request 1130. In one example, if process request 1130 may be delayed, user device 110 may decide to delay implementation of process request 1130 in order to conserve energy, as indicated by reference number 1140. Delaying process request 1130 may conserve energy because, for example, process request 1130 may cause the package order system to be operated in an inefficient manner. If user device 110 determines that process request 1130 cannot be delayed, user device 110 may enable process request 1130 to be implemented in service process 1110 (e.g., modify the package order system's operating parameters), as indicated by reference number 1150.

### CONCLUSION

Systems and/or methods described herein may schedule execution of processes and process requests, in an energy-aware way, based on levels of urgency associated with the processes or process requests, current state information associated with process resources (e.g., devices, tools, equipment, etc.), power consumption information associated with the execution of the processes and the process requests, environmental factors, etc. The systems and/or methods may consider these factors individually and/or in an interrelated manner. The systems and/or methods may operate in conjunction with an existing OS state controller (e.g., a process scheduler and/or a hardware controller) of a user device (e.g., a computer, a server, a cluster of computers, etc.).

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 9, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as a “component” that performs one or more functions. This component may include hardware, such as an ASIC or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set. No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a computing device, the method comprising:
receiving, by the computing device, a request associated with a process;
determining, by the computing device, one or more current states of one or more process resources used to execute the process request;
calculating, by the computing device, a power consumption associated with execution of the process request by the one or more process resources;
assigning, by the computing device, an urgency for the process request, where the urgency corresponds to a time-variant parameter that indicates a measure of necessity for the execution of the process request;
determining, by the computing device, whether the execution of the process request can be delayed to a future time based on the one or more current states, the power consumption, and the urgency;
causing, by the computing device and when the execution of the process request cannot be delayed, the process request to be executed; and
causing, by the computing device and when the execution of the process request can be delayed, a delay of the execution of the process request to the future time.

2. The method of claim 1, further comprising:
identifying one or more projected processes scheduled to execute at the future time;
calculating a projected power consumption associated with an execution of the one or more projected processes; and
determining whether the execution of the process request can be delayed to the future time based on the projected power consumption.

3. The method of claim 1, further comprising:
identifying a projected state of one of the one or more process resources; and
determining whether the execution of the process request can be delayed to the future time based on the projected state.

4. The method of claim 1, further comprising:
receiving one or more environmental factors associated with the one or more process resources; and
determining whether the execution of the process request can be delayed to the future time based on the one or more environmental factors.

5. The method of claim 4, where the environmental factors include one or more of production demands, process utilization, power availability, target performance, current power consumption, or cooling reserves.

6. The method of claim 1, further comprising:
assigning a threshold value of urgency associated with execution of the process request;
comparing the urgency to the threshold value of urgency to determine whether the urgency exceeds the threshold value of urgency; and
determining whether the execution of the process request can be delayed to the future time based on the comparing.

7. The method of claim 1, further comprising:
calculating a projected urgency for the process request based on an urgency rate that provides a rate of change of the urgency through time; and
determining whether the execution of the process request can be delayed to the future time based on the projected urgency.

8. The method of claim 1, where the causing the process request to be executed comprises:
sending the process request to a scheduler, where the scheduler schedules the execution of the process request via the one or more process resources.

9. The method of claim 1, where the process comprises one of a manufacturing process or a service process.

10. A device, comprising:
a memory to store instructions; and
a processor to execute instructions in the memory to:
receive a request associated with a process,
determine one or more current states of one or more process resources used to execute the process request,
calculate a power consumption associated with execution of the process request by the one or more process resources,
assign an urgency for the process request, where the urgency corresponds to a time-variant parameter that indicates a measure of necessity for the execution of the process request,
determine whether the execution of the process request can be delayed to a future time based on the one or more current states, the power consumption, and the urgency, and
cause, based on the determination, the process request to be executed or delayed to the future time.

11. The device of claim 10, where the processor is further to execute instructions in the memory to:
identify one or more projected processes scheduled to execute at the future time,
calculate a projected power consumption associated with an execution of the one or more projected processes, and
determine whether the execution of the process request can be delayed to the future time based on the projected power consumption.

12. The device of claim 10, where the processor is further to execute instructions in the memory to:
identify a projected state of one of the one or more process resources, and
determine whether the execution of the process request can be delayed to the future time based on the projected state.

13. The device of claim 10, where the processor is further to execute instructions in the memory to:
receive one or more environmental factors associated with the one or more process resources, and
determine whether the execution of the process request can be delayed to the future time based on the one or more environmental factors.

14. The device of claim 10, where the processor is further to execute instructions in the memory to:
assign a threshold value of urgency associated with execution of the process request,
compare the urgency to the threshold value of urgency to determine whether the urgency exceeds the threshold value of urgency, and
determine whether the execution of the process request can be delayed to the future time based on the comparison.

15. The device of claim 10, where the processor is further to execute instructions in the memory to:
calculate a projected urgency for the process request based on an urgency rate that provides a rate of change of the urgency through time, and
determine whether the execution of the process request can be delayed to the future time based on the projected urgency.

16. The device of claim 10, where the processor is further to execute instructions in the memory to:
send the process request to a scheduler, where the scheduler schedules the execution of the process request via the one or more process resources.

17. The device of claim 10, where the memory further stores:
an operating system that includes a scheduler to execute the process request via the one or more process resources.

18. The device of claim 17, where, when receiving the process request, the processor is further to execute instructions in the memory to one of:
retrieve the process request from a memory source shared with the scheduler, or
obtain the process request based on a communication with the scheduler.

19. The device of claim 10, where the process comprises one of a manufacturing process or a service process.

20. One or more computer-readable media storing instructions executable by one or more processors, the media storing one or more instructions for:
receiving a request associated with a process;
determining one or more current states of one or more process resources used to execute the process request;
calculating a power consumption associated with execution of the process request by the one or more process resources;
assigning an urgency for the process request, where the urgency corresponds to a time-variant parameter that indicates a measure of necessity for the execution of the process request;
determining whether the execution of the process request can be delayed to a future time based on the one or more current states, the power consumption, and the urgency;
causing, when the execution of the process request cannot be delayed, the process request to be executed; and
causing, when the execution of the process request can be delayed, a delay of the execution of the process request to the future time.
